(19) United States
(12) Patent Application Publication
(10) Pub. No.: US 2025/0345849 A1
(43) Pub. Date: Nov. 13, 2025

(54) Freeze Drying and Tumble Drying of Flake Powder

(71) Applicant: KEMET Electronics Corporation, Fort Lauderdale, FL (US)

(72) Inventors: James Allen Fife, Simpsonville, SC (US); Liliana Vela, Tamaulipas (MX); Mary Lou Lindstrom, Oxford, ME (US)

(21) Appl. No.: 19/273,836

(22) Filed: Jul. 18, 2025

Related U.S. Application Data
(62) Division of application No. 17/019,937, filed on Sep. 14, 2020, now abandoned.

(51) Int. Cl. B22F 1/068; B22F 3/16; B22F 9/04; F26B 5/06; F26B 11/02; H01G 4/008; H01G 9/00; H01G 13/00

(52) U.S. Cl. CPC B22F 1/068; B22F 3/16; B22F 9/04; F26B 5/065; F26B 11/02; H01G 4/008; B22F 2301/20; H01G 9/0029; H01G 13/00

(57) ABSTRACT

Provided is a process for providing a flake powder characterized by a particle size of −40 mesh to +200 mesh; a Scott density of at least 1.458 g/cm³; and a flow of at least 1 g/s. The process includes introducing a milled flake powder in a solvent to a first dryer; removing the solvent at a temperature below a melting point of the solvent under a reduced atmosphere to obtain a partially dry flake powder; and introducing the partially dry flake powder to a second dryer to form flake powder wherein particles of partially dry flake powder are heated and simultaneously subjected to an uncorrelated motion relative to adjacent particles.

### FIELD OF THE INVENTION

The present invention is related to an improved method for forming flake powder and preferably flake tantalum powder. More specifically, the present invention is related to an improved method for forming an anode from a monolith formed from flake powder having a high surface area and minimal binder residue.

### BACKGROUND

The demand for electronic components with ever increasing functionality has been ongoing for decades. The demand for functionality has been complicated by the parallel desire for smaller devices resulting in contradictory demands of higher functionality and smaller volume. These competing trends have led to an ever-increasing pressure on component manufacturers to provide smaller components without sacrificing functionality. For the purposes of the present invention the competing desire for increased functionality in a smaller volume has resulted in significant advances in capacitors and, particularly, tantalum-based capacitors.

Tantalum-based capacitors typically comprise a sintered monolith of pressed tantalum powder. A dielectric is formed on the monolith and a cathode is formed on the dielectric. An important aspect of the capacitance, or charge density, of the capacitor is the nature of the powder with increased surface area being desirable. The desire for increased surface area has led those of skill in the art to the use of tantalum flakes as described in commonly assigned U.S. Pat. No. 9,514,890 which is incorporated herein by reference. Though the use of tantalum flakes is now an advanced art the achievable charge density has still lagged expectations based on theoretical predictions. It has long been thought that agglomeration and sintering processes, which are necessary to produce commercially usable products, are the culprit in the inability of tantalum flakes to achieve the charge density expected by theory.

High surface area tantalum is desirable as an anode material for capacitors because of the direct relationship between capacitance and surface area. The surface area needs to be conserved during the various processing steps such as drying, agglomeration and sintering. Drying and sintering create challenges due to various mass transport effects, diffusion effects and surface tension effects which occur during these processing steps. The removal of solvents from solid particles, typically in the form of a slurry, is often done using conventional evaporative drying methods where the solid/liquid mixture is heated to temperatures near that of the evaporation temperature of the solvent.

It is desirable for high surface area flaked tantalum powder to have a Scott density in the range of 24 g/in³ to 35 g/in³ and a Hall flow greater than 1 g/s, in order to facilitate anode pellet fabrication using conventional automatic powder pressing machines. The relatively large, prior art flakes described in U.S. Pat. No. 5,580,367 required to be mechanically broken using an impact milling after hydride embrittlement of the flakes in order to raise the Scott density from less than 16 g/in³ to the desirable range required for pressing. In the present invention after milling, we achieve very high BET flakes with diameters about 100 times smaller than the prior art flakes that do not require processing in high energy impact mills before agglomeration, In addition, the present invention flakes are so small and compliant that the forces of surface tension caused by exposure to water during acid treating results in the present invention flakes to be so tightly packed in clusters during drying that the Scott density is typically higher than the desirable range. Further, the invention flakes, as is shown in example 1, suffer large loss of surface area after agglomeration steps.

Through diligent research, the instant inventors have determined, contrary to the expectations in the art, that the process of drying is far more critical than ever considered. While not limited to theory, it has now been determined that with tantalum flakes the flakes tend to stack during drying which significantly decreases surface area since the faces are covered by adjoining flakes. The irreversible surface area loss remains after anode sintering, but the cause of the loss is not revealed by conventional methods such as BET or CV/g and so the cause was difficult to recognize; and, the complex solution to successful drying was unexpected and is still not fully understood.

Yet another problem in the art is associated with the necessity of a binder when pressing tantalum powder into a monolith. The binder provides lubrication between the particles during pressing and adheres particles to each other. After pressing and before sintering, the binder is removed. Binder has always been considered necessary since tantalum powder particles do not adhere adequately for handling. Unfortunately, the binder leaves a residue of carbon which remains in the final capacitor. It has previously been considered necessary to include the binder and therefore the residual carbon has been accepted as an unavoidable impurity.

In spite of the previous efforts a novel method of drying tantalum flake powders has been developed which results in a significant increase in surface area, an elimination of the necessity of binders and the resulting flake powder has flow characteristics which are previously unavailable in the art.

### SUMMARY OF THE INVENTION

The present invention is related to an improved method for forming flake powder, and particularly flake tantalum powder, and an improved flake powder formed by the method.

More specifically, the present invention is related to the formation of a monolith formed from sintered flake powder, particularly sintered flake tantalum powder, wherein the monolith is particularly suitable for use as an anode of a capacitor.

A particular feature of the invention is the ability to form a flake powder, and particularly flake tantalum powder, which can be formed into a monolith without the necessity of a binder.

Yet another particular feature is the ability to form an anode, and a capacitor comprising the anode, with improved electrical properties.

These and other embodiments, as will be realized, are provided in a flake powder characterized by a particle size of −40 mesh to +200 mesh; a Scott density of at least 1.458 g/cm³; and a flow of at least 1 g/s.

Yet another embodiment is provided in a process for forming a flake powder. The process includes:
introducing a milled flake powder in a solvent to a first dryer;
removing the solvent at a temperature below a melting point of the solvent under a reduced atmosphere to obtain a partially dry flake powder; and
introducing the partially dry flake powder to a second dryer to form flake powder wherein particles of partially dry flake powder are optionally heated and simultaneously subjected to an uncorrelated motion relative to adjacent particles.

Yet another embodiment is provided in a method for forming a capacitor. The method includes:
forming a flake powder by:
introducing a milled flake powder in a solvent to a first dryer;
removing the solvent at a temperature below a melting point of the solvent under a reduced atmosphere to obtain a partially dry flake powder; and
introducing the partially dry flake powder to a second dryer to form flake powder wherein particles of the partially dry flake powder are optionally heated and simultaneously subjected to an uncorrelated motion relative to adjacent particles;
pressing the flake powder into a monolith;
sintering the monolith to form an anode;
forming a dielectric on the anode; and
forming a cathode on the dielectric.

### BRIEF DESCRIPTION OF DRAWINGS

FIG. 1 is a schematic representation of a prior art embodiment.

FIG. 2 is a schematic representation of an embodiment of the invention.

FIG. 3 is a flow chart representation of an embodiment of the invention.

FIG. 4 is a cross-sectional schematic view of an embodiment of the invention.

### DESCRIPTION

The present invention is related to an improved flake powder, and method of drying powders to achieve the flake powder, wherein the initial drying is accomplished by sublimation followed by drying during uncorrelated motion, referred to herein as tumble drying. Tumble drying is preferably done without the use of milling media in the tumble dryer. More specifically, the present invention is related to a method of forming a monolith of sintered flake powder, preferably without the use of binder, wherein the monolith is suitable for use as an anode for a capacitor with improved electrical properties. Flaked tantalum powder is particularly preferred.

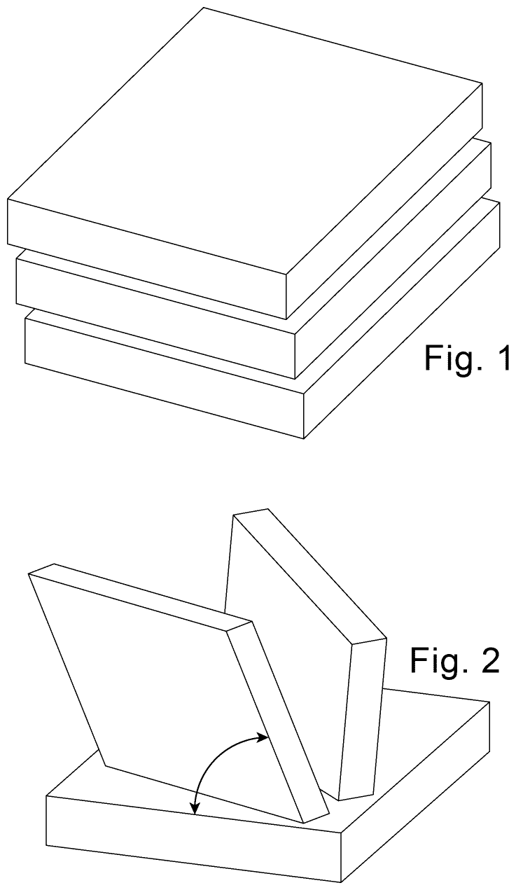

The importance of achieving an open stacking pattern, thereby avoiding a decrease in the surface area of the bulk powder, has been a long-standing desire. The prior art method of drying the flake, such as by evaporative drying under atmospheric pressure, is now realized to cause particle consolidation wherein the particles stack, as in a deck of cards as illustrated schematically in FIG. 1, resulting in a reduction in surface area. It is surprisingly realized that sublimation drying followed by tumble drying, preferably without milling media, inhibits the randomly aligned flake particles from consolidating resulting in near spherical nodules of free-flowing high surface area powder. It is further now surprisingly realized that the resulting powder does not require binder and therefore there is a significant decrease in residual carbon typically present from the burnt-out binder.

While not limited to this theory, it is hypothesized that the novel drying process inhibits the flake particles from stacking in a parallel relationship, as discussed above, but instead the flakes form an open stack, represented schematically without limit thereto, in FIG. 2. The open stack has significantly more surface area as would be realized and demonstrated herein. The inventive process results in the formation of a flake valve metal powder, particularly flake tantalum powder, wherein hundreds of flakes agglomerate to form relatively spherical clusters more than 100 microns in diameter, yet the high surface area expected from the flakes remains inside these agglomerates.

The invention will be described with reference to the figures forming an integral, non-limiting, component of the disclosure. Throughout the various figures similar elements will be numbered accordingly.

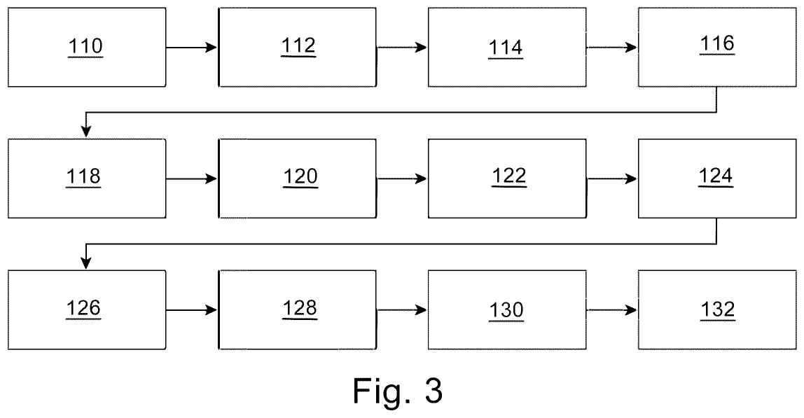

The process for forming flake powder will be described with reference to FIG. 3 wherein the process is represented schematically as a flow chart.

The process of forming a flake powder begins with a nodular powder and particularly a nodular tantalum powder, 10, which is milled, 12, preferably with low energy milling providing a high surface area platelet like powder referred to as a milled flake powder. The milled flake powder, which is preferably a milled flake tantalum powder, is then separated from the milling media and subjected to a first leaching to remove impurities, 14. After the first leaching the milled flake powder is dried by freeze drying, 16, to form partially dried flake powder, and preferably partially dried flake tantalum powder, which is optionally and preferably screened, 18, to obtain a low-density partially dried flake powder with a Scott Density of less than 1.0 g/cc. The partially dried flake powder is tumble dried, 20, to form nearly spherical agglomerates of the flake powder, and preferably flake tantalum power, followed by optional heat treatment, 22, to further purify and mechanically stabilize the agglomerates of the flake powder. The oxide concentration is reduced, 24, preferably by introduction to magnesium vapor which has a higher affinity for oxygen than valve metals and particularly tantalum. The magnesium and magnesium oxide is removed by acid leading, 26. The acid leached powder is dried, 29, screened, 30 and optionally packaged, 32.

Low energy milling is preferred due to the ability to provide a milled flake powder, particularly a milled flake tantalum powder, having a high CV/g, high surface area and a high aspect ratio. The improved milled flake powder is produced by mechanical ball milling, attritor milling, vibratory ball milling, or roll milling using very small milling media. The milling media preferably has an average diameter of at least 0.001 cm to no more than 0.3175 cm. More preferably the milling media has an average diameter of at least 0.025 cm to 0.1 cm and even more preferably the milling media has an average diameter of at least 0.025 cm to 0.030 cm.

The milling is preferably done with low milling energies such as achieved at an RPM of an attritor mill of less than 120 RPM. The particles are milled to high BET surface area over several hours. The resultant particles have a BET surface area which is 2 to 4 times higher than the BET surface area of the particles fed to the mill and the surface impurities of the resultant particles are maintained at low levels. It Is preferable that the nodular powder is milled to provide a milled flake powder having a BET of greater than 4 M²/g, more preferably greater than 5 M²/g, even more preferably greater than 6 M²/g, even more preferably at least 7 M²/g, even more preferably at least 8 M²/g and even more preferably at least 9 M²/g. The milled particles preferably have a low level of metallic impurity and preferably no more than 30 ppm metal other than the valve metal. More preferably the milled particles have no more than 30 ppm of iron, nickel and chromium combined and more importantly no more than 30 ppm of iron, nickel, chromium, silicon and zirconium combined. Carbon impurity is also preferably low with a preferred carbon content of lower than about 23 μg/M² of particle surface being preferred and more preferably less than about 18 μg/M² of particle surface.

The kinetic energy applied to the milling media particles in the mill during low-energy milling can be defined quantitatively as KE=0.5*ρ_{Media}*v_{Media}*V² where ρ_{Media} is the density of the media material in grams per cubic centimeter, vMedia is the volume of an average media object, for instance a spherical media ball, in cubic centimeters, and V is the maximum speed of the stirring mechanism of the mill that imparts kinetic energy to the media objects during the milling operation expressed as centimeters per second.

As an example of how to perform this calculation consider an attritor mill configuration wherein a vertical cylindrical tank is filled with 0.1 cm diameter spherical steel media which are propelled by a stirring mechanism composed of horizontally positioned metal arms of length, L, attached to and rotating about a centrally positioned vertical drive shaft. The tip speed, V, of such rotating metal arms, which would be the maximum stirring speed of the milling mechanism, is calculated as V=L*RPM*(2π/60) where the length of the stirring arms, L, is given in centimeters and RPM is the rotations per minute of the drive shaft. In this example the final calculation of the maximum kinetic energy of an average media object would use the density of the spherical steel media ρ_{Media} equal to about 8 grams per cubic centimeter (the typical density of steel), and vMedia would be set equal to (4/3)*πr³ where r is the average radius of the steel spheres in centimeters. If, for this example, a diameter of the media sphere is 0.1 cm is assumed with a stirring arm length of 10 centimeter and the mill RPM is 200 the kinetic energy per sphere is 0.5*8* 4/3*π*(0.1/2)³*(10*200*²*π/60)²=91.87 ergs. Milling energy above about 3,000 ergs per milling media sphere cause impurities to increase which is undesirable. More preferably the milling energy is less than about 1,000 ergs and even more preferably less than 100 ergs. A milling energy of no more than 5 ergs per milling media sphere is particularly suitable with no more than 2 ergs being more desirable and no more than 1 erg being most desirable.

The media is preferably chosen from the group consisting of spherical steel, zirconia, yttria stabilized zirconia, 440 stainless steel, glass, tungsten carbide, tantalum, niobium, tantalum nitride, niobium nitride, tantalum carbide and mixtures thereof. The mixtures may include structured materials such as a core shell structure with an inner material which is softer and an outer material which is harder. An example of grinding media made of mixed materials would be a tantalum sphere coated with tantalum nitride.

The particles being milled to form milled flake powder are preferably valve metal particles selected from the group consisting of tantalum, niobium, tungsten, titanium, aluminum and alloys thereof. Tantalum is the preferred valve metal.

The flakes of the milled flake powder preferably have an average aspect ratio, determined as the ratio of the diameter with the same surface area as a flake to the thickness, of at least 3 to about 300. More preferably, the flakes have an average aspect ratio of at least 10 and more preferably at least 100. An average aspect ratio of about 200 to about 300 is particularly preferred. The flaked powder permits enhanced surface area due to its morphology.

After low-energy milling it is preferable to acid leach the powder to remove impurities.

The milled flaked powder is initially dried by sublimation to form partially dried flake powder. Freeze drying is exemplary for demonstration of the invention. Freeze drying is accomplished at low temperature under reduced pressure wherein the solvent, preferably water, is removed by sublimation. During freeze drying the temperature of the sample to be dried is preferably pre-frozen, such as at −20° C. for a sufficient time to insure all of the solvent in the sample is solid. The frozen sample is then subjected to a reduced pressure wherein the frozen solvent in the sample sublimes and is collected in a separate chamber or on a cold coil. The conditions of freeze drying are not particularly limited with the exception of the temperature and pressure being sufficiently low to ensure the solvent does not reach a liquid phase. With water as the solvent the sample temperature is preferably below about 0° C. and the pressure is below about 0.006 atm (4.4 torr) with a lower temperature and lower pressure being preferred. The sample cools by adiabatic cooling so additional cooling of the sample during freeze drying is not necessarily required. It may be preferable to apply a low level of heat to increase the rate of sublimation with the understanding that the heat should not increase the sample above the freezing point of the solvent. In a particularly preferred embodiment, a collection vessel is employed wherein the temperature of the collection vessel is well below the temperature of the sample thereby ensuring the sublimed solvent remains preferentially in the collection vessel. In an exemplary method the sample is cooled to about −20° C. which is sublimed at less than about 0.1 torr into a collection vessel maintained at about −56° C. The partially dried flake powder, which is preferably partially dried flake tantalum powder, preferably has a Scott density of less than about 1 g/cc.

The partially dried flake powder is preferably screened to isolate powder particles suitable for formation into a monolith. Screening to obtain powder with particle sizes between a 100 mesh to 200 mesh is suitable for demonstration of the invention. For the purposes of the disclosure a powder designated as a negative mesh size indicates powder having a size sufficient to pass through the screen. For example, a powder represented as −40 mesh passed through a 40 mesh screen whereas a powder represented as +40 mesh is powder that was oversized relative to a 40 mesh screen and therefore remains on the screen. A designation such as −100 mesh to +200 mesh indicates a powder with a size suitable to go through a 100 mesh screen but not through a 200 mesh screen and therefore the powder has a defined range of powder sizes.

The partially dried flake powder, optionally screened, is dried by heat during uncorrelated motion of adjacent particles which is referred to herein as tumble drying. The uncorrelated motion is due to interaction with a moving surface. Tumble drying is preferably done without grinding media, therefore, the motion does not appreciably alter the gross morphology of the powder particles and inhibits particles consolidating as drying proceeds. In a particularly preferred embodiment tumble drying is accomplished in a drum rotating on an axis wherein the axis is at an angle which is neither parallel nor perpendicular to level as defined by a bubble-level. The rotation of the drum allows particles to tumble approximately randomly due to combined interaction with the surface of the drum and with other particles in motion within the drum. Other moving surfaces are suitable for demonstration of the invention include vibrating platen, preferably at an angle relative to bubble-level. The uncorrelated motion of adjacent particles inhibits adjacent particles from consolidating. In order to further purify and increase the strength of the agglomerates formed during the tumbling operation an optional heat treatment may be applied to the powder. This may be performed in a vacuum furnace, such as those made by Solar Atmospheres in Souderton Pennsylvania, or in an inert gas furnace as made by Centorr Vacuum Industries in Nashua New Hampshire. High temperatures may be used, for example 1050° C. or greater, in order to establish strong metallurgical bonds between the flakes inside the agglomerate clusters.

It is preferable to remove oxygen, which is either dissolved oxygen or oxygen as a metal oxide, from the powder. The oxygen is preferable removed by magnesium. In the deoxidation or leaching process the powder is loaded into a vacuum furnace with an appropriate amount of Mg. The furnace is heated to a temperature sufficient to vaporize the Mg and the temperature is maintained until available oxygen is interacted with Mg and form MgO. In an exemplary embodiment about 6 gms of Mg is sufficient to deoxidize about 453 to 680 g of tantalum material in about 3 hrs at about 1000° C. The material is then leached to remove MgO residue.

The leaching process completes the formation of the native oxide layer while removing any hydrogen produced. This also removes the MgO in the deoxidized valve metal materials. Leaching can be accomplished in an aqueous mineral acid. A particularly suitable wash solution for removing MgO is a dilute aqueous solution of sulfuric acid and hydrogen peroxide.

In the leaching process deoxidized powder is washed with leach solution such as a mixture of hydrogen peroxide and sulfuric acid in a concentration sufficient to leach the magnesium oxide in the desired time. As would be realized to those of skill in the art a wide range of hydrogen peroxide and sulfuric acid can be used with more highly concentrated solutions being more rapid. By way of example, without limit thereto, an aqueous solution comprising about 11.3 vol % of H₂O₂, 35% concentrated, and 4.7 vol % H₂SO₄, 98% concentrated, is mixed with 84 vol % deionized DI water and held for about 4 hours. In some embodiments, more aggressive leach solutions such as 50 Vol % HNO₃, 68% concentrated, and 50 vol % of deonized water can be used. The leached parts are then washed thoroughly and dried in an oven preferably at about 85° C. until the parts are dry. A second leaching can be performed if desired.

After removal of the MgO the powder is dried by conventional techniques, screened and packaged in a manner suitable for transport or for transfer to the pressing operation. Conventional atmospheric drying is appropriate at this stage of processing because the thermal processing steps of heat treatment and magnesium deoxidation have metallurgically stabilized the random arrangement of the flakes achieved through the tumbling step of the invention.

The particular feature of the inventive powder is the flowing characteristics. Flake powder dried by conventional methods has a very low flow, measured as grams of powder flowing through a funnel per second. For the instant invention flow is measured in a Hall Flow Meter with a calibrated Hall Flow Funnel having an orifice diameter of 0.2 inch. A non-vibrated flow of at least 1 g/s is a relatively free flowing powder. Flow is preferably at least 2 g/s, more preferably at least 3 g/s and even more preferably at least 4 g/s. Flow typically does not exceed 8 g/s with the desirable particle size ranges.

The inventive flake powder achieves a higher density than flake made with prior art techniques with a Scott density of at least 1.458 g/cm³ (23.9 g/in³) and more preferably at least 1.464 g/cm³ (24 g/in³) being achievable particularly with a flow of over 1 g/s.

The flake powder, preferably flake tantalum powder, is pressed into a monolith with the anode wire in the powder during pressing.

A particular advantage of the instant invention is the elimination of the requirement for binder. Binder can be used. However, it serves no useful purpose, adds costs, and results in carbon residue after sintering. If a lubricant or binder is used the lubricant or binder is removed by heating in vacuum, or by washing in aqueous detergents.

The monolith undergoes sintering in vacuum in a sintering furnace at sintering temperatures equal or slightly lower than conventionally used sintering temperatures. Sintering temperatures are preferably about 1,100° C. to about 1,800° C. and typically about 1,250° C.

Valve metals, and particularly tantalum, has a high affinity for oxygen and therefore a sudden exposure of post sintered high surface area anodes to oxygen will result in bulk oxides which are detrimental to electrical properties. This may also result in thermal oxidation, leading to non-uniform native oxide formation and possible run-away oxidation. Subsequent exposure to moisture, water or electrolyte can result in hydrogen embrittlement of the anode wire. It is preferred to utilize controlled exposure of the sintered anode to oxygen over time thereby limiting the oxide formation to the surface. This technique is referred to herein as “passivation” or “progressive step passivation”.

Passivation is performed preferably immediately after sintering in a vacuum or inert gas furnace and cooling to a lower temperature than the sintering temperature preferably with initial introduction of less than the stoichiometric amount of oxygen necessary to form native oxide. Formation of the native oxide is exothermic and therefore the amount of oxygen added in each aliquot during passivation is below that amount necessary to raise the temperature of the anode to 60° C. and more preferably, the amount of oxygen in each aliquot is no more than that amount necessary to raise the temperature of the anode to 50° C. As would be realized the amount of oxygen in each aliquot is partially dependent on the temperature prior to the addition of the aliquot with ambient, or near ambient, being preferred for manufacturing efficiency. With each aliquot added the temperature rise as a function of oxygen added decreases and therefore the amount of oxygen can increase per aliquot as the number of aliquots increases. The anodes can be cooled, such as by flowing an inert gas over the anode, between aliquots if desired.

In passivation the amount of oxygen required to stoichiometrically form the native valve metal oxide layer is a function of surface area and is determinate. Typical native surface oxide for Ta, as an example, is equivalent to a dielectric layer formed at 1.167V wherein about 18 angstroms of oxide is formed per volt. Using the surface area of the sintered anode, the total mass of stoichiometric oxygen needed can be calculated, using tantalum for the purposes of discussion, by the following equation:

$$Weight of O ( g ) / Weight of Ta ( g ) = BET ( {m}^{2} / g of Ta ) \times {10}^{4} ( c {m}^{2} / {m}^{2} ) \times 1.167 V \times 18 Å / V \times {10}^{- 8} ( cm / Å ) \times 8.2 ( density of {Ta}_{2} {O}_{5} g / {cm}^{3} ) \times 0.182 ( g O / g {Ta}_{2} {O}_{5} ) \times {10}^{6} μg O / g O ;$$

and
dividing this result by BET, which is the surface area, yields the optimum ratio of O (ppm)/BET of 3100 (μg O/m²) or about 0.31 μg/cm².

Passivation is accomplished using dry air as a medium to provide the required oxygen. The amount of air volume is calculated at standard temperature and pressure (STP) in terms of cubic centimeters at STP (SCC), or Torr, where STP is 25° C. and 1 atmosphere. Passivation is preferably carried out in multiple steps at a temperature not exceeding 60° C. wherein a portion of the total oxygen necessary to achieve stoichiometric native oxygen is introduced at each step. More preferably the passivation temperature does not exceed 50° C. By way of non-limiting example; 10% of the required air volume could be provided in a first step, 20% in a second step, 30% in a third step and the final 40% in a fourth step and therefore by the end of passivation cycle, which is four steps in this example, 100% of the required oxygen is provided. Each step can be followed by a hold time sufficient to allow the temperature to decrease to the extent necessary to ensure a subsequent aliquot of oxygen does not allow the temperature to rise above 60° C. and more preferably not above 50° C. The number of steps in the passivation schedule is not particularly limited, it can vary anywhere from 2 steps to 100 steps with air volume % ranging from 1% to 99% in each step. In some instances, more than a stoichiometric amount of oxygen is added to increase the surface oxide layer with the proviso that the temperature does not exceed the maximum temperature for passivation. It is preferable that no more than 250% of the calculated stoichiometric oxygen be introduced during passivation.

After passivation in air, it is sometimes desirable to further passivate the anode. It is advantageous to use the same sulfuric acid-hydrogen peroxide solution used in leaching to complete the passivation of the anode and wire.

It is preferable to utilize the monolith as an anode in a capacitor. The anode is anodized to form a dielectric on the surface wherein the dielectric is preferably an oxide of the valve metal. Anodization is well known in the art and the method of anodizing is not particularly limited herein. Other dielectrics could be incorporated without departing from the scope of the invention but oxides of the anode are widely used in the art.

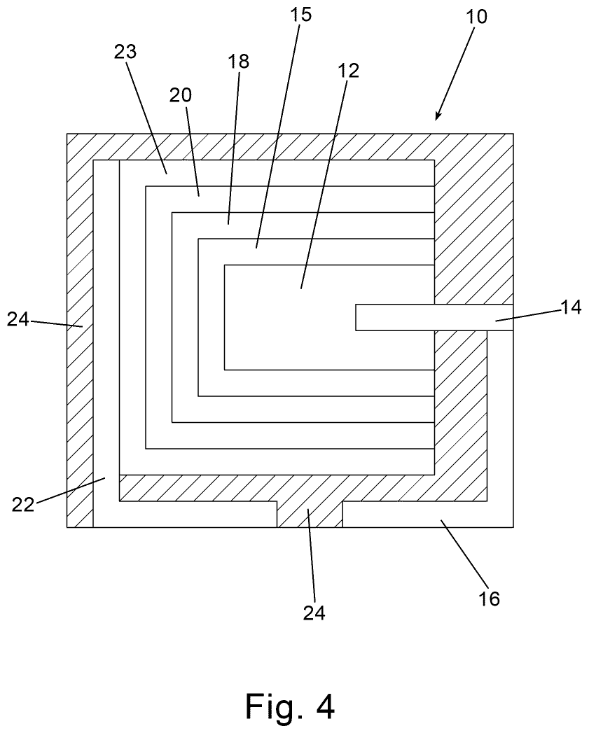

An embodiment of the invention is illustrated in cross-sectional schematic side view in FIG. 4. In FIG. 4, a capacitor, generally represented at 10, comprises an anodized anode, 12, with an anode lead wire, 14, extending therefrom or attached thereto. The anode lead wire is preferably in electrical contact with an anode lead, 16. An optional, preferably in-situ formed, precursor conductive layer, 15, is formed on the anodized anode and preferably the precursor conductive layer at least partially encases a portion of dielectric of the anodized anode. Alternatively, the precursor conductive layer is formed by coating and curing of a soluble conductive polymer solution. A first conductive polymer layer, 18, and subsequent conductive polymer layer(s), 20, as a cathode layer are formed sequentially on the precursor conductive layer and at least partially encase at least a portion of the first conductive layer and form an encasement around at least a portion of the dielectric. As would be realized to those of skill in the art the cathode and anode are not in direct electrical contact in the finished capacitor. A cathode lead, 22, is in electrical contact with the cathode layers. It is well understood that electrically connecting a lead frame, or external termination, to a polymeric cathode is difficult. It has therefore become standard in the art to provide conductive interlayers, 23, which allow good electrical and mechanical adhesion to the lead frame. In many embodiments it is preferred to encase the capacitor in a non-conductive resin, 24, with at least a portion of the anode lead and cathode lead exposed for attachment to a circuit board as would be readily understood by one of skill in the art.

A cathode layer is formed on the dielectric. The cathode is a conductive layer and may be formed from conductive polymers, such as conductive thiophenes, with polyethylenedioxythiophene derivatives being exemplary for use in the demonstration of the invention. Other cathode layers, such as manganese dioxide, which is a conductive semiconductor, are suitable for use in demonstration of the invention.

It is widely understood that external terminations are difficult to form on the cathode, particularly with a conductive polymeric cathode, and transition layers are typically applied to the cathode layer to facilitate termination. In particular, carbon layers overcoated with metal layers, such as silver or nickel, are suitable for demonstration of the invention. The capacitor is typically finished. Finishing may include attachment of external terminations, encapsulating in an insulator, testing, packaging and the like.

The anode wire preferably comprises a valve metal and most preferable niobium or tantalum due to the advantages provided by the use of magnesium as a reducing agent with these valve metals. Other valve metals can be used with the proviso that a reducing agent having a higher oxygen affinity than the valve metal will be required. Tantalum is preferred as the anode and most preferably doped tantalum is preferred. It is preferable that the tantalum of the anode wire be doped. Particularly suitable dopants include Yttrium (Y), Silicon (Si), Cerium (Ce), Carbon (C), Germanium (Ge), Palladium (Pd), Platinum (Pt), Rhenium (Rh), Molybdenum (Mo), Lanthanum (La), Neodymium (Nd), Thallium (Th) and others.

### EXAMPLES

The valve metal powder described herein is particularly suited for use as the anode in a capacitor. The valve metal is preferably oxidized to form a dielectric and the dielectric is over coated with a conductor as well known in the art.

The flake tantalum powder of the present invention can be fabricated into anodes which have a CV/g of preferably between 110,000 micro-farad volts per gram of valve metal and 180,000 micro-farad volts per gram of valve metal, preferably of tantalum, and even more preferably at least 200,000 micro-farad volts per gram of valve metal, preferably of tantalum, and even more preferably at least 250,000 micro-farad volts per gram of valve metal, preferably of tantalum. Low CV/g nodular powders, such as less than 30,000 micro-farad volts per gram can be treated to become flake shaped to significantly increase the CV/g thereby significantly increasing the value of the powder. More preferably, nodular powders with less than 50,000 micro-farad volts per gram can be treated to significantly increase the CV/g and even more preferably, powders with less than 100,000 micro-farad volts per gram can be treated to significantly increase the CV/g.

Conventional drying method was air drying at 75° C. in a laboratory oven.

Removing solvent by sublimation was done by freeze drying in a LABCONCO laboratory freeze dry after cryogenic freezing with liquid nitrogen. LABCONCO 600 mL Fast Freeze freeze-dry flasks (LABCONCO Part #7540800). The milled flake tantalum powder was pre-frozen in a freezer to a temperature of −20° C. for 75 minutes to ensure all of the solvent was frozen. The freeze dry flasks were then attached to a LABCONCO FreeZone 6 Liter Benchtop Freeze Dry System (Model Series 77520) equipped with an Edwards LABCONCO 195 Pump (Model #N03885600) by a 12-port manifold (LABCONCO Part #7522800) and ¾″ stainless steel adapters. The collection chamber sustained a temperature of −56° C. during the freeze-drying cycle and the pressure set point for freeze drying was 0.075 torr. The product temperature remained between −15° C. to −20° C. during the primary drying stages at the core of the sample. Heat energy was applied to the product using the ambient temperature of the environment, which ranged between 15° C.-21° C., and heat transfer through the borosilicate freeze dry flasks. The freeze-drying cycle times varied based on the load of milled flake tantalum powder and volume of solvent that had to be sublimated. The freeze dry cycle was ended when the residual mass in the freeze dry flasks was accounted for only by partially dried flake tantalum powder. The partially dried flake tantalum powder was screened to capture the fraction passing through a 100 mesh screen but captured by a 200 mesh screen.

For the tumble-drying step, the partially dried flake tantalum powder was dried in a rotating 16 inch stainless steel drum rotating at 36 rpm for 5 minutes at 25° C. The axis of rotation was between vertical and horizontal, but was preferably about 45° from vertical.

If heat treatment was performed, it was done at 1050° C. in a Solar Atmospheres furnace.

The advantages provided by the inventive combination of sublimation drying and tumble drying is illustrated in Examples 3 and 4 and 5 wherein the Scott Density, Flow, BET and their ability to be pressed into anodes with high CV/g are exceptional.

### Example 1

Comparative Example Using Prior Art Air Drying in Conjunction with Tumble Drying

3.85 kgs of KBP52 basic lot tantalum powder, with a BET of 1.65 meters squared per gram was milled using an Attritor ball mill made by Union Process in Akron Ohio. The attritor mill used anhydrous ethanol as a lubricant and contained 50 kgs of 40/100 mesh solid tantalum spheres as media. Milling was continued until the milled flake reached a BET of 5.0 meters squared per gram. The flake was acid leached to remove impurities. Further it was conventionally air dried in an electrical resistance oven at 75° C. The bulk Scott density of the material after being screened −100 mesh was 21.47 g/in³ and the powder did not flow through a Hall flow funnel with 5 mm diameter aperture. The sample was then dry tumbled at 25° C. in a 16-inch diameter, stainless-steel drum rotating clockwise for 10 minutes at 36 rpm. After tumbling the flake had a bulk Scott density of 23.83 g/in³. The powder at this stage did not flow through a Hall flow funnel with 5 mm diameter aperture.

The sample was then heat treated at 1050° C. for 30 minutes in a Solar Atmospheres vacuum furnace at which point the bulk density had decreased to 21.67 g/in³. The sample was magnesium deoxidized by exposure to magnesium vapor at 850° C.; and later, acid leached to remove magnesium residue and other impurities.

The bulk density finally achieved was low at 24.65 g/in³ and the powder remained non-flowing. The BET had reduced to a low value of 2.3 square meters per gram.

Next the sample was pressed at 6.2 g/cc in order to attempt making anodes to measure the CV/g; however, because of the very poor flow the anodes did not properly fill the press die and the pellets fell apart immediately after pressing and no electrical measurements were possible for this sample.

### Example 2

### Comparative Example Using Freeze Drying, but not Followed by Tumble Drying

Flake tantalum powder was prepared like that in example 1 with a BET of 5.0 square meters per gram. The flake was then freeze dried to remove the solvent by sublimation using a LABCONCO laboratory freeze dryer after cryogenic freezing with liquid nitrogen. LABCONCO 600 ml Fast Freeze freeze-dry flasks (LABCONCO Part #7540800). The flake tantalum powder was pre-frozen in a freezer to a temperature of −20° C. for 75 minutes to ensure all of the solvent was frozen. The freeze dry flasks were then attached to a LABCONCO FreeZone 6 Liter Benchtop Freeze Dry System (Model Series 77520) equipped with an Edwards LABCONC 195 pump (Model #N03885600) by a 12-port manifold (LABCONCO Part #7522800) and ¾″ stainless steel adapters. The collection chamber sustained a temperature of −56° C. during freeze-drying cycle and the pressure set point for freeze drying was 0.075 torr. The product temperature remained between −15° C. to −20° C. during the primary drying stages at the core of te sample. Heat energy was applied to the product using the ambient temperature of the environment, which ranged between 15° C. and 21° C., and heat transfer through the borosilicate freeze dry flasks. The freeze-drying cycle times varied based on the load of milled flake tantalum powder and volume of solvent that had to be sublimated and the ambient temperature. The freeze dry cycle was ended when the residual mass in the freeze dry flasks was accounted for by only partially dried flake tantalum powder. The partially dried flake tantalum powder was screened to 100/200 (−100 to +200) mesh.

The Scott Density was 16.29 g/in³ at this point and the powder was non-flowing through a Hall flow funnel with 5 mm diameter aperture.

The powder was not tumble dried after freeze drying, as is taught in the present invention, but was rather next heat treated to a max temperature of 1050° C. The bulk density minimally increased to 16.45 g/in³ and the flow of this powder was very low at 0.36 g/s; that is, not free flowing. This sample was magnesium deoxidized by magnesium vapor at 850° C. and subsequently acid leached to remove impurities.

The final bulk density was very low at 15.79 g/in³ and the product remained not free flowing. The final BET was low at 2.5 square meters per gram.

### Example 3

### Inventive Example Using Freeze Drying and Tumble Agglomeration.

Flake tantalum powder was prepared by attritor milling the same as example 1 with a BET of 5.0 square meters per gram. This sample was acid leached to remove impurities. The flake was then freeze dried using a LABCONCO laboratory freeze dryer as in Example 2. The sample was then screened through a 100-mesh screen. The bulk density after screening was 16.29 g/in³ and the powder would not flow through a Hall flow funnel. The sample was then tumbled at 45 degrees from vertical per the teaching of the present invention at 36 rpm for 10 minutes achieving a bulk density to 28.09 g/in³. This sample was not optionally heat treated as is one embodiment of the present invention, but instead was only subjected to magnesium deoxidation at 850° C.

The final Scott Density and flow of the sample after being subjected to magnesium deoxidation was good at 26.76 g/in³ and flow was exceptionally good at 4.63 g/s. The BET was good at 3.6 square meters per gram.

The flake tantalum powder was pressed into rectangular anodes 0.231 cm×0.167 cm×0.103 cm (0.0908 in.×0.0659 in.×0.0407 in). The powder wt. of 0.0230 gm was pressed to a density of 6.0 g/cc with an anode wire size having a diameter of 0.300 mm (0.0118 inch) inserted therein. The anodes were sintered at 1120° C. for 15 minutes. The anodes were formed to 16 volts. Capacitance was measured at 120 Hz with 1.5 volt bias. The results are

TABLE 1
Electrical test results

| CV/g | |
|---|---|
| (μC-V/g) | nA/(μC-V) |
| 120600 | 5.07 |
| 119500 | 6.73 |
| 119300 | 4.11 |
| 111100 | 4.45 |
| 120900 | 3.89 |
| Mean = 118300 | Mean = 4.85 |

### Example 4

### Inventive Example Made Using Freeze Drying Followed by Tumble Drying at 25° C.:

Flake tantalum powder was attritor milled to a BET of 5.0 square meters per gram as in Example 1 and was subsequently freeze dried as in Example 2. The partially dried flake tantalum powder was screened to −100 mesh and tumble dried at 25° C. using a 16 inch diameter barrel, held at 45 degree angle from horizontal, rotating at 50 rpm for 15 min.

The yield of −40 mesh product from the tumbler was 51% and the Scott density of the tumble-dried flake tantalum powder was 27.1 grams/in³.

The flake tantalum powder was heat treated using a vacuum furnace with a molybdenum hot zone made by Solar Atmospheres of Souderton Pennsylvania at a temperature of 1050° C. The heat treated flake tantalum powder was deoxidized by magnesium vapor at a temperature of 850° C.

The Scott density of the finished powder was excellent at 33.69 g/in³ and the BET showed good retention of the surface area at 3.2 square meters per gram. The powder flow rate through a Hall flow funnel with 5 mm aperture was excellent at 6.0 g/s.

The flake tantalum powder was pressed into rectangular anodes 0.231 cm×0.167 cm×0.103 cm (0.0908 in.×0.0659 in.×0.0407 in). The powder wt. of 0.0237 gm was pressed to a density of 6.2 g/cc with an anode wire size having a diameter of 0.300 mm (0.0118 inch) inserted therein. The anodes were sintered at 1130° C. for 15 minutes. The anodes were formed to 16 volts. The results are in Table 1.

TABLE 2
Electrical test results

| | CV/g | |
|---|---|---|
| | (μC-V/g) | nA/(μC-V) |
| | 118800 | 2.76 |
| | 116800 | 2.94 |
| | 118800 | 3.87 |
| | 117500 | 3.1 |
| | 112100 | 4.39 |
| | 118800 | 3.7 |
| mean= | 117133.3 | 3.46 |

### Example 5

### Inventive Example Made Using Freeze Drying Followed by Warm Tumbling Drying at 53° C.:

Flake tantalum powder was attritor milled to a BET of 5.0 square meters per gram as in Example 1 and was subsequently freeze dried as in Example 2. The partially dried flake tantalum powder was screened to −100 mesh and was tumble dried as in Example 4; however, in this example the tumbler vessel was maintained at 53° C. The flake tantalum powder formed −40 mesh spherical powder with a yield of 70%, a Scott density of 28.16 g/in³ and a free-flowing rate of 4.97 g/s. This flake tantalum powder was subsequently heat treated at 1050° C. to stabilize the structure and the residual BET surface area showed good retention of surface area with 3.2 square meters per gram. The final flow rate was 4.69 g/s and the final scott density was very good at 29.67 g/in³.

The flake tantalum powder was pressed into rectangular anodes 0.231 cm×0.167 cm×0.103 cm (0.0908 in.×0.0659 in.×0.0407 in). The powder wt. of 0.0237 gm, pressed to a density of 6.2 g/cc. An anode wire with an 0.300 mm (0.0118 inch) diameter was embedded in the powder prior to pressing. The anodes were sintered at 1130° C. for 15 minutes followed by forming to 16 volts. The results are in Table 2.

TABLE 3
Electrical test results

| | CV/g | na/CV |
|---|---|---|
| | 118300 | 2.075 |
| | 119000 | 1.88 |
| | 116000 | 2.04 |
| | 119000 | 2.21 |
| | 119000 | 2 |
| | 125700 | 2.05 |
| | 118300 | 1.75 |
| | 118300 | 2.1 |
| | 120300 | 4.66 |
| | 117600 | 2.29 |
| | 121700 | 2.18 |
| mean= | 119382 | 2.29 |

The above five examples are summarized in Table 3.

TABLE 4

| | | | Heat | Final | | Yield | | Final |
|---|---|---|---|---|---|---|---|---|
| | Flake | Tumble Dry | Treat | Flow | Final | of −40 | | Scott |
| | dry | Temperature | Temp | rate | BET | after | CV/g | density |
| Example | method | (° C.) | (° C.) | (g/s) | M²/g | tumbling | (μC-V/g) | (g/in³) |
| 1 | Air Dry | 25 | 1050 | 0 | 2.3 | N/A | Not | 24.65 |
| Comparative | | | | | | | pressable | |
| 2 | Freeze | N/A | 1050 | 0 | 2.5 | N/A | Scott too | 15.79 |
| Comparative | Dry | | | | | | low | |
| 3 | Freeze | 25 | N/A | 4.63 | 3.6 | N/A | 118,300 | 26.76 |
| Inventive | Dry | | | | | | | |
| 4 | Freeze | 25 | 1050 | 6.0 | 3.2 | 51% | 117,133 | 33.69 |
| Inventive | Dry | | | | | | | |
| 5 | Freeze | 53 | 1050 | 4.69 | 3.2 | 70% | 119,382 | 29.67 |
| Inventive | Dry | | | | | | | |

The invention has been described with reference to the preferred embodiments without limit thereto. Additional embodiments and improvements may be realized which are not specifically set forth herein but which are within the scope of the invention as more specifically set forth in the claims appended hereto.

1-17. (canceled)

18. A process for forming a flake powder comprising:
introducing a milled flake powder in a solvent to a first dryer;
removing said solvent at a temperature below a melting point of said solvent under a reduced atmosphere to obtain a partially dry flake powder; and
introducing said partially dry flake powder to a second dryer to form flake powder wherein particles of said partially dry flake powder are heated and simultaneously subjected to an uncorrelated motion relative to adjacent particles.

19. The process for forming a flake powder of claim 18 wherein said flake powder agglomerate is characterized by:
a particle size of −40 mesh to +200 mesh;
a Scott density of at least 1.458 g/cm³; and
a flow of at least 1 g/s.

20. The process for forming a flake powder of claim 19 wherein said flow is at least 2 g/s.

21. The process for forming a flake powder of claim 20 wherein said flow is at least 3 g/s.

22. The process for forming a flake powder of claim 21 wherein said flow is at least 4 g/s.

23. The process for forming a flake powder of claim 19 wherein said flow is no more than 8 g/s.

24. The process for forming a flake powder of claim 19 wherein said Scott density is at least 1.464 g/cm³.

25. The process for forming a flake powder of claim 19 wherein said particle size is −40 mesh to +100 mesh.

26. The process for forming a flake powder of claim 18 wherein said charge density of said flake powder is at least 180,000 μFV/g.

27. The process for forming a flake powder of claim 26 wherein said charge density is at least 200,000 μFV/g.

28. The process for forming a flake powder of claim 27 wherein said charge density is at least 250,000 μFV/g.

29. The process for forming a flake powder of claim 18 further comprising low energy milling of a nodular powder to form said milled flake powder.

30. The process for forming a flake powder of claim 29 wherein said low energy milling is at less than 100 ergs per milling media sphere.

31. The process for forming a flake powder of claim 30 wherein said low energy milling is at less than 5 ergs per said milling media sphere.

32. The process for forming a flake powder of claim 31 wherein said low energy milling is at less than 2 ergs per milling said media sphere.

33. The process for forming a flake powder of claim 32 wherein said low energy milling is at less than 1 ergs per said milling media sphere.

34. The process for forming a flake powder of claim 29 wherein said low energy milling achieves a BET of said milled flake powder of at least 4 M²/g.

35. The process for forming a flake powder of claim 34 wherein said low energy milling achieves a BET of said milled flake powder of at least 5 M²/g.

36. The process for forming a flake powder of claim 35 wherein said low energy milling achieves a BET of said milled flake powder of at least 6 M²/g.

37. The process for forming a flake powder of claim 36 wherein said low energy milling achieves a BET of said milled flake powder of at least 7 M²/g.

38. The process for forming a flake powder of claim 37 wherein said low energy milling achieves a BET of said milled flake powder of at least 8 M²/g.

39. The process for forming a flake powder of claim 38 wherein said low energy milling achieves a BET of said milled flake powder of at least 9 M²/g.

40. The process for forming a flake powder of claim 18 wherein said flake powder comprises less than 30 ppm of iron, nickel, chromium, silicon and zirconium combined.

41. The process for forming a flake powder of claim 18 wherein said flake powder comprising a valve metal.

42. The process for forming a flake powder of claim 41 wherein said valve metal is selected from the group consisting of tantalum, niobium, tungsten, titanium, aluminum and alloys thereof.

43. The process for forming a flake powder of claim 42 wherein said valve metal is tantalum.

44. The process for forming a flake powder of claim 18 wherein said flake powder has a carbon content of less than 23 μg/M² of particle surface.

45. The process for forming a flake powder of claim 44 wherein said carbon content is less than 18 μg/M² of particle surface.

46. The process for forming a flake powder of claim 18 wherein said flake powder has an average aspect ratio of at least 3 to 300.

47. The process for forming a flake powder of claim 18 wherein said second dryer does not contain milling media.

48. The process for forming a flake powder of claim 18 further comprising leaching said milled flake powder.

49. The process for forming a flake powder of claim 18 further comprising deoxygenating said flake powder.

50. A method for forming a capacitor comprising:
forming a flake powder by:
introducing a milled flake powder in a solvent to a first dryer;
removing said solvent at a temperature below a melting point of said solvent under a reduced atmosphere to obtain a partially dry flake powder; and
introducing said partially dry flake powder to a second dryer to form flake powder wherein particles of said partially dry flake powder are heated and simultaneously subjected to an uncorrelated motion relative to adjacent particles;
pressing said flake powder into a monolith;
sintering said monolith to form an anode;
forming a dielectric on said anode; and
forming a cathode on said dielectric.

51-81. (canceled)
